(19) United States
(12) Patent Application Publication
(10) Pub. No.: US 2003/0002423 A1
(43) Pub. Date: Jan. 2, 2003

(54) Information medium with multi-layered structure, and apparatus and method using this medium

(76) Inventors: Yoriyuki Ishibashi, Kawasaki-shi (JP); Hideo Ando, Hino-shi (JP)

Correspondence Address: PILLSBURY WINTHROP, LLP, P.O. BOX 10500, MCLEAN, VA, 22102, US

(21) Appl. No.: 10/183,029

(22) Filed: Jun. 27, 2002

(30) Foreign Application Priority Data
Jun. 29, 2001 (JP) 2001-198754

(51) Int. Cl. G11B 7/00

(52) U.S. Cl. 369/94; 369/283

(57) ABSTRACT

An upper recording layer is arranged on a portion having distance h from the disc surface, a lower recording layer is arranged on a portion having distance h+Δh from the disc surface, a space layer having thickness Δh is arranged between the upper and lower recording layers, and a cover layer having thickness h is arranged between the upper recording layer and disc surface. Thickness Δh of the space layer is specified, so that a coherence length (Lc) which is determined by central wavelength λ₀ and its half-width Δλ of the exit light power spectrum of a laser beam is smaller than the optical path difference (ΔL) between light u₀ which is directly reflected by the surface of the cover layer, and light u₂ which is transmitted through the cover layer and space layer, is reflected by the lower recording layer, and leaves the cover layer.

### CROSS-REFERENCE TO RELATED APPLICATIONS

This application is based upon and claims the benefit of priority from the prior Japanese Patent Application No. 2001-198754, filed Jun. 29, 2001, the entire contents of which are incorporated herein by reference.

### BACKGROUND OF THE INVENTION

1. Field of the Invention

The present invention relates to an improvement in a disc structure suitable for a next-generation DVD (Digital Versatile Disc) with a one-sided multi-layered structure using a short-wavelength laser (blue laser or the like).

More particularly, the present invention relates to an improvement in a disc structure that can achieve stable focus detection by suppressing interference between light reflected by the disc surface and light reflected by a (lower) information recording layer.

2. Description of the Related Art

As prior art that can achieve stable focus detection by suppressing interference between light reflected by the disc surface and light reflected by an information recording layer, “focusing device and optical disc apparatus using the same” described in Japanese Patent No. 3128247 is known. With the device of this reference, interference between light reflected by the disc surface and light reflected by the information recording layer is suppressed by suppressing the half-width (Δλ) of a laser light source to be equal to or smaller than a predetermined value.

More specifically, the above device is characterized in that half-width Δλ is set so that coherence length Lc determined by central wavelength λ₀ and half-width Δλ of an exit light power spectrum of a laser light source is smaller than optical path difference ΔL between light which is directly reflected by the substrate surface of the disc, and light which enters the substrate, is reflected by a signal pit of the information recording layer, and leaves the substrate again. In this way, interference between light directly reflected by the disc surface, and light reflected by a recording/reproduction surface of the information recording layer is prevented, thus allowing stable focus detection/focus control.

According to the prior art described in the above patent, if a disc to be used has a one-sided, single-layered structure, noise due to “interference of reflected light” does not appear in a focus signal, thus allowing satisfactory focus detection. However, if a disc to be used has a one-sided, two-layered (or multi-layered) structure, the interference suppression effect for an upper recording layer can be expected, but that for a lower recording layer cannot be expected.

### BRIEF SUMMARY OF THE INVENTION

An information medium with a multi-layered structure according to an aspect of the present invention pays attention to the thickness of a space layer between two neighboring information recording layers, and the thickness of this space layer is specified so as to prevent interference between light directly reflected by the medium surface, and light which is transmitted through a first information recording layer and the space layer, and is reflected by a second information recording layer.

An information medium with a multi-layered structure according to an aspect of the present invention comprises a lower recording layer formed on a substrate, an upper recording layer formed on the lower recording layer via a space layer having a first predetermined thickness (Δh), and a cover layer which has a second predetermined thickness (h) and is formed on the upper recording layer.

In this information medium with the multi-layered structure, let λ₀ be the central wavelength of a light beam used to read recorded information from the lower recording layer or upper recording layer, Δλ be the broadening or half-width of the wavelength of this light beam, n₂ be the refractive index of the space layer, and NA be the numerical aperture of an objective lens used to focus the light beam on the lower recording layer or upper recording layer. Then, the first predetermined thickness (Δh) of the space layer is determined by the difference between a length (λ₀²/(2·Δλ√[n₂²−NA²]), which is determined by λ₀, Δλ, n₂, and NA, and the second predetermined thickness (h) of the cover layer.

More specifically, if Δh represents the first predetermined thickness, and h represents the second predetermined thickness, Δh is determined based on:

Δh≧λ₀²/(2·Δλ√[n₂²−NA²])−h

or

Δh≧λ₀²/(2·λ·[n₂²−NA²]^{1/2})−h

A one-sided, two-layered optical disc as an information medium with a multi-layered structure according to another aspect of the present invention has a structure in which a substrate having thickness H is used, a first recording layer formed with signal pits is arranged on a portion having distance h from the surface, a second recording layer formed with signal pits is also arranged on a portion having distance h+Δh from the surface, a space layer having thickness Δh is arranged between the first recording layer and the second recording layer, and a cover layer having thickness h is arranged between the first recording layer and the disc surface.

In the optical disc with such structure, the thickness (Δh) of the space layer is specified, so that a coherence length (Lc) determined by the central wavelength (λ₀) and its half-width (Δλ) of an exit light power spectrum of a light source, which emits a laser beam with which the first recording layer or second recording layer is irradiated, is smaller than an optical path difference (ΔL) between light (u₀) which is directly reflected by the surface of the cover layer, and light (u₂) which is transmitted through the cover layer and the space layer, is reflected by the second recording layer, and leaves the disc from the cover layer.

Let λ₀ be the central wavelength of the laser beam, Δλ be the half-width of the wavelength of the laser beam, n₂ be the refractive index of the space layer, NA be the numerical aperture of an objective lens used to focus the laser beam on the lower recording layer or upper recording layer, Δh be the thickness of the space layer, and h be the thickness of the cover layer. Then, Δh can be determined based on:

Δh≧λ₀²/(2·Δλ√[n₂²−NA²])−h

or

Δh≧λ₀²/(2·Δλ·[n₂²−NA²]^{1/2})−h

An apparatus according to yet another aspect of the present invention is configured to record or reproduce information using a laser beam having central wavelength λ₀ (e.g., a blue laser beam with λ₀=400 to 420 nm) with respect to the upper recording layer or lower recording layer of the information medium with the multi-layered structure.

Furthermore, an apparatus according to yet another aspect of the present invention is configured to irradiate the information medium with the multi-layered structure with a laser beam emitted by a light source via an objective lens, and to record information on a first recording layer or second recording layer or to reproduce information from the first recording layer or second recording layer by the irradiated laser beam. Note that a focus error (ΔZ in FIG. 4) of the objective lens is detected on the basis of a signal (outputs Ia to Id from 213) obtained by detecting some light components of the laser beam which is reflected by the first recording layer or second recording layer.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the preferred embodiments given below, serve to explain the principles of the invention.

FIG. 1 is a view for explaining the structure of an information medium (next-generation DVD disc) according to an embodiment of the present invention;

FIG. 2 is a view for explaining an optical system used for the information medium shown in FIG. 1;

FIG. 3 is a front view of a photosensor which is built in the optical system shown in FIG. 2 and is used to acquire a focus error signal;

FIG. 4 is a graph for explaining the characteristics of the focus error signal detected by the photosensor shown in FIG. 3; and

FIG. 5 is a block diagram for explaining an optical disc apparatus according to an embodiment of the present invention.

### DETAILED DESCRIPTION OF THE INVENTION

An information medium with a multi-layered structure and an apparatus using this medium according to various embodiments of the present invention will be described hereinafter with reference to the accompanying drawings.

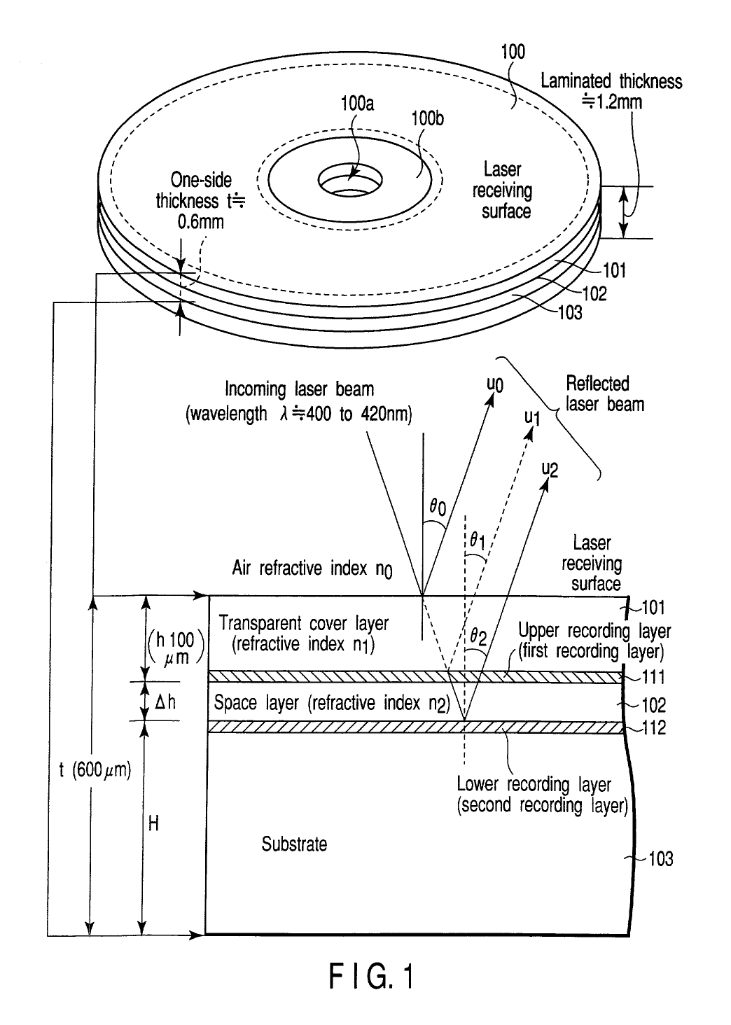

FIG. 1 is a view for explaining the structure of an information medium (next-generation DVD disc) according to an embodiment of the present invention. Optical disc 100 shown in FIG. 1 is manufactured to comply with high-density/large-capacity “next-generation DVD standards” which will be standardized soon, and has a structure shown in, e.g., FIG. 1. In this embodiment, especially, a “one-sided, two-layered disc” having a space layer of next-generation DVD discs 100 will be explained.

Next-generation DVD disc 100 shown in FIG. 1 comprises transparent cover layer 101, upper recording layer (first recording layer) 111 used to record/reproduce information, space layer 102, lower recording layer (second recording layer) 112 used to record/reproduce information, and substrate 103 in turn from the disc surface side. Two multi-recording layer substrates with such structure (each having a total thickness of about 0.6 mm) are laminated (or a multi-recording layer substrate with such structure and a 0.6-mm thick dummy substrate are laminated) to obtain laminated disc 100 having an overall thickness of about 1.2 mm.

In other words, cover layer 101 as the disc surface is formed of a light-transmitting substrate (polycarbonate or the like) having refractive index n₁, semi-transparent first recording layer (metal thin film, ultrathin phase-change recording layer, or the like) 111, which has pits corresponding to recorded information such as compressed moving picture information, and transmits and reflects light, is deposited on the back surface (substrate side) of cover layer 101, and the distance from the surface of cover layer 101 to first recording layer 111 is h. Also, second recording layer 112 having the same purpose as first recording layer 111 is formed at a position separated Δh (corresponding to the thickness of space layer 102) from first recording layer 111. Surface cover layer 101, space layer 102, and substrate 103 are adhered by a light transmitting adhesive (ultraviolet setting resin or the like) to sandwich first and second recording layers 111 and 112 therebetween.

At the center of next-generation DVD disc 100, clamping hole 100a used upon clamping disc 100 on a spindle motor/turn table (not shown) of a disc drive is formed, and clamping zone 100b is assured around hole 100a.

In the embodiment shown in FIG. 1, thickness h of transparent cover layer 101 is selected to be 100 μm (nominal value or design central value in the manufacture), and thickness Δh of space layer 102 is selected to be an appropriate value (e.g., around 10 to 30 μm) equal to or smaller than thickness h of transparent cover layer 101. Also, thickness H of substrate 103 is selected (e.g., H=0.5 mm or less) so that a total thickness including the thicknesses of cover layer 101, upper recording layer 111, space layer 102, and lower recording layer 112 is about 0.6 mm.

Upper recording layer 111 must be semi-transparent since it must transmit a laser beam, and is formed to be very thin (e.g., 1 μm or less). On the other hand, the thickness of lower recording layer 112 that need not transmit a laser beam can be arbitrarily set (note that the depth of a recorded pit is determined in accordance the wavelength of a laser beam; it is, e.g., the depth around ¼ of the wavelength of a laser beam).

When disc 100 does not adopt any laminated structure of 0.6 mm×2, lower recording layer 112, space layer 102, upper recording layer 111, and cover layer 101 having a thickness of around 0.1 mm may be stacked and adhered in the order named on substrate 101 having a thickness of 1.1 mm or less.

Another lower recording layer (third recording layer; not shown) may be formed below lower recording layer 112 via a second space layer (not shown). That is, the information medium with the multi-layered structure according to the present invention is not limited to a one-sided, two-layered disc.

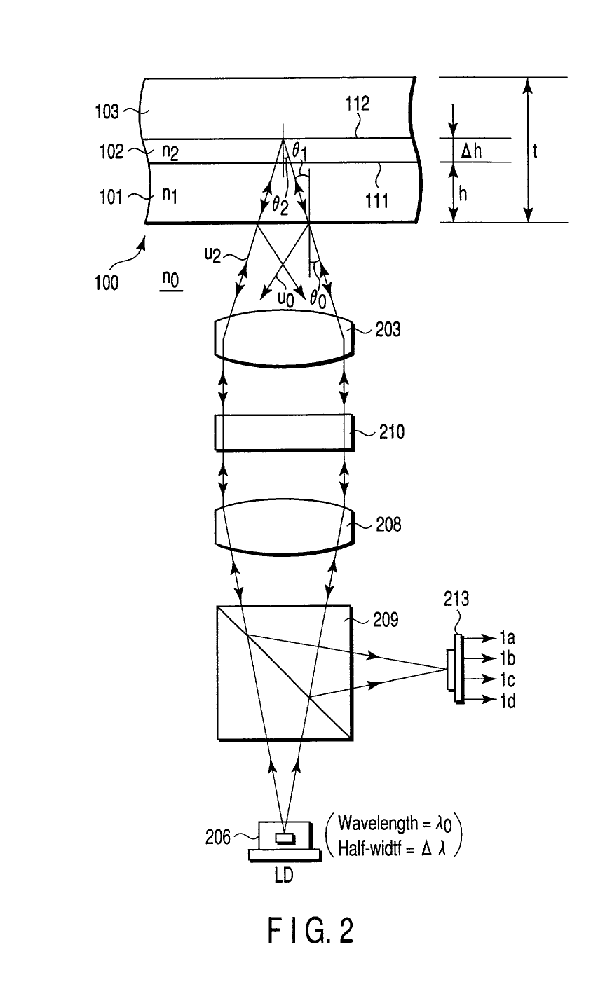

FIG. 2 is a view for explaining an optical system used for the information medium shown in FIG. 1. Referring to FIG. 2, a laser beam which is emitted by laser diode LD 206 and is transmitted through polarization beam splitter 209 is converted into a collimated beam by collimate lens 208, and the collimated beam is guided to objective lens 203 via ¼-wave plate 210. The collimated beam that has reached objective lens 203 is focused by objective lens 203, and enters optical disc 100 from the side of cover layer 101. In this example, numerical aperture NA of objective lens 203 is 0.85 based on the next-generation DVD standards.

Focusing attention on thickness Δh of space layer 102 of two-layered disc 100, how to determine its prescribed value will be explained below. As shown in FIGS. 1 and 2, let h be the thickness of cover layer 101, Δh be the thickness of space layer 102, n₂ be the refractive index of space layer 102, θ₂ be the refracting angle of an incoming light beam in space layer 102, θ₂max be the maximum angle of that refracting angle (n₂×sin θ₂max=NA), n₀=1 be the refractive index of ambient air (air), λ₀ be the central wavelength of a laser beam emitted by laser diode LD 206, i.e., an incoming light beam, and Δλ be the half-width of that wavelength. At this time, two-layered disc 100 which satisfies:

Δh≧λ₀²/(2·Δλ√[n₂²−NA²])−h

or

Δh≧λ₀²/(2·Δλ·[n₂²−NA²]^{1/2})−h (1)

is used.

A. Examples of the value of Δh that satisfies relation (1) (i.e., the lower limit value of thickness Δh of space layer 102) are as follows.

<Example 1> If λ₀=403 nm, Δλ=0.5 nm, n₂=1.57, NA=0.85, and h=100 μm, Δh≧23 μm is obtained. Roughly speaking (e.g., one effective digit), the value of Δh is determined to have a value approximately ⅕ (20 μm) of the value (nominal 100 μm) of thickness h of cover layer 101 as the lower limit in this “example 1”.

<Example 2> If λ₀=440 nm, Δλ=0.44 nm, n₂=1.44, NA=0.935, and h=100 μm, Δh≧100 μm is obtained. In this “example 2”, the value of Δh is determined to have the thickness (100 μm) of cover layer 101 as the lower limit.

<Example 3> If λ₀=360 nm, Δλ=0.36 nm, n₂=1.76, NA=0.765, and h=100 μm, Δh≧14 μm (in case of two effective digits) is obtained. Roughly speaking (e.g., one effective digit), the value of Δh is determined to have approximately 10 μm as the lower limit in “example 3” (the lower limit=10 μm includes the range of the lower limit=100 μm of “example 2”).

Upon generalizing numerical value examples of “example 2” and “example 3” above, “if Δλ is set to be 400 nm±10%, Δλ is set to be 0.1% or less of λ₀, n₂ is set to be 1.6±10%, NA is set to be 0.85±10%, and h is set to be 100 μm, Δh is determined to have the range of 10 μm to 14 μm as the lower limit”.

Note that relation (1) does not specify the upper limit of Δh, but the physical structure of disc 100 is preferably designed so that thickness Δh of space layer 102 does not exceed thickness h (100 μm in this case) of cover layer 101 from a practical standpoint. Likewise, thickness Δh of space layer 102 is preferably selected to fall within, e.g., the range from 10 μm to 30 μm as not too a small but not too a large value.

B. Other examples of the value of Δh that satisfies relation (1) (i.e., the lower limit value of thickness Δh of space layer 102) are as follows.

<Example 4> If λ₀=400 nm, Δλ=0.5 nm, n₂=1.62, NA=0.85, and h=100 μm, Δh≧16 μm is obtained. Roughly speaking (e.g., one effective digit), the value of Δh is determined to have a value approximately ⅕ (20 μm) of the value (nominal 100 μm) of thickness h of cover layer 101 as the lower limit in this example. Under substantially the same condition except that n₂=1.65, Δh≧13 μm is obtained. Roughly speaking (e.g., one effective digit), the value of Δh is determined to have a value approximately 1/10 (10 μm) of the value (nominal 100 μm) of thickness h of cover layer 101 as the lower limit in this example.

<Example 5> If λ₀=400 nm, Δλ=1.0 nm, n₂=1.62, NA=0.85, and h=100 μm, Δh=−42 μm is obtained. In this case, relation (1) does not hold. However, even when “Δλ=1.0 nm, Δh becomes larger than zero depending on the values of λ₀, n₂, NA, h, and the like (on a practical surface, Δh becomes larger than a value 1/10 of h) in some cases (for example, a material with small refractive index n₂ is selected, and an object lens with large numerical aperture NA is used to reduce the value of [n₂²−NA²]^{1/2}). For this reason, Δλ=1.0 nm is adopted as a possible numerical value range.

Upon generalizing “example 4” and “example 5”, they can be summarized as follows: λ₀₌400 nm to 405 nm, Δλ=0.1 nm to 1.0 nm, n₂=1.61 to 1.62, NA=0.85±0.01, and h=100 μm±1 μm.

In this embodiment, the range from 400 nm to 405 nm is selected as that of wavelength λ₀. This is because the transmittance of an existing objective lens abruptly drops at a wavelength of 400 nm or lower, and the influence of chromatic aberration begins to be conspicuous at a wavelength of 405 nm or higher in an existing objective lens.

In this embodiment, the range from 0.1 nm to 1.0 nm is selected as that of half-width Δλ. This is because this range corresponds to the variation range of half-width Δλ of a currently available red laser diode for DVD. In this connection, half-width Δλ of a blue laser diode which is currently easily available is around 0.5 nm.

In this embodiment, the range from 1.61 to 1.62 is selected as that of refractive index n₂. This is because “relationship between refractive index n and wavelength λ” basically satisfies “dn/dλ<0”, and the range “1.61 to 1.62” is obtained when this relation is applied to the aforementioned wavelength range (400 nm to 405 nm).

In this embodiment, the range of 0.85±0.01 is selected as that of numerical aperture NA of the objective lens. The reason why the variation width of NA is set to be “±0.01” is that variations of NA of an objective lens for an existing DVD may fall within this range.

In this embodiment, the range of 100 μm±1 μm is selected as the range of thickness h of the cover layer. This is because the thickness nonuniformity of a thin film sheet, which is prepared in advance and forms the cover layer, may fall within the range of 100 μm±1 μm.

As shown in FIGS. 1 and 2, let h be the thickness of cover layer 101, Δh and n₂ be the thickness and refractive index of space layer 102, θ₂ be the refracting angle of an incoming light beam in space layer 102, θ₂max be the maximum angle of that refracting angle (n₂×sin θ₂max=NA), n₀=1 be the refractive index of air, λ₀ be the central wavelength of a laser beam emitted by laser diode LD 206, i.e., an incoming light beam, and Δλ be the half-width of that wavelength. Then, optical path difference ΔL between light u₀ reflected by the disc surface and light u₂ reflected by lower recording layer 112 is given by:

ΔL=2·n₂·(h+Δh)·cos θ₂ (2)

Also, from the Snell laws of refraction,

n₀·sin θ₀=n₁·sin θ₁=n₂·sin θ₂ (3)

is satisfied.

On the other hand, coherence length Lc of a laser beam is given by:

Lc=λ₀²/Δλ (4)

When optical path difference ΔL is shorter than coherence length Lc, light waves interfere with each other between the surface of cover layer 101 and lower recording layer (second recording layer: reflecting layer) 112 of optical disc 100. In such case, when optical disc 100 suffers thickness nonuniformity in the circumferential or radial direction, or suffers thickness variations for respective manufactures, a focus error signal drifts in synchronism with rotation of optical disc 100 due to the influence of interference. As a result, accurate focusing control is disturbed, resulting in S/N (signal-to-noise ratio) drop of a reproduced signal and an increase in jitter.

However, when two-layered disc 100 in which thickness Δh of space layer 102 satisfies relation (1) (e.g., Δh=10 μm to 30 μm or more), coherence length Lc given by equation (4) can be shorter than optical path difference ΔL given by equation (2) (ΔL>Lc). Consequently, light wave interference between light uₒ reflected by the surface of cover layer 101 and light u₂ reflected by lower recording layer (second recording layer) 112 of next-generation DVD disc 100 can be prevented.

Note that we will prove that “ΔL>Lc” is satisfied in “example 1” to “example 3” above. (Since a laser beam is controlled to hit to form nearly right angles with the disc surface, it is handled as “cos θ₂≈1”. For example, even when θ₂ has a tilt of 1° (at most), since cos [1°]≈0.9998, “cos θ₂≈1” can be used.)

<Example 1> If λ₀=403 nm, Δλ=0.5 nm, n₂=1.57, NA=0.85, and h=100 μm, Δh≧23 μm is obtained. In this example, the lower limit value=23 μm is adopted as the value of Δh.

In this case, equation (2) yields ΔL=2·n₂·(h+Δh)·cos θ₂≈2×1.57×(100+23)≈386 μm, and equation (4) yields Lc=λ₀²/Δλ=403×403/0.5=324818 nm 325 μm. That is, ΔL≈386 μm>Lc≈325 μm, and the light wave interference can be prevented.

When the lower limit value of Δh is 20 μm, equation (2) yields ΔL=2·n₂·(h+Δh)·cos θ₂≈2×1.57×(100+20)≈377 μm. In this case as well, since ΔL≈377 μm>Lc≈325 μm, the light wave interference can be prevented.

<Example 2> If λ₀=440 nm, Δλ=0.44 nm, n₂=1.44, NA=0.935, and h=100 μm, Δh≧100 μm is obtained. In this example, the lower limit value=100 μm is adopted as the value of Δh.

In this case, equation (2) yields ΔL=2·n₂·(h+Δh)·cos θ₂≈2×1.44×(100+100)≈576 μm, and equation (4) yields Lc=λ₀²/Δλ=440×440/0.44=440 μm. That is, ΔL≈576 μm>Lc=440 μm, and the light wave interference can be prevented.

<Example 3> If λ₀=360 nm, Δλ=0.36 nm, n₂=1.76, NA=0.765, and h=100 μm, Δh≧14 μm is obtained. The lower limit value=14 μm is adopted as the value of Δh. In this example, the lower limit value=14 μm is adopted as the value of Δh.

In this case, equation (2) yields ΔL=2·n₂·(h+Δh)·cos θ₂≈2×1.76×(100+14)≈401 μm, and equation (4) yields Lc=λ₀²/Δλ=360×360/0.36=360 μm. That is, ΔL≈401 μm>Lc=360 μm, and the light wave interference can be prevented.

When the lower limit value of Δh is 10 μm, equation (2) yields ΔL=2·n₂·(h+Δh)·cos θ₂≈2×1.76×(100+10)≈387 μm. In this case as well, since ΔL≈387 μm>Lc=360 μm, the light wave interference can be prevented.

“Example 1” to “example 3” easily clear the interference prevention condition “ΔL>Lc”. For this reason, even when the angle of the beam that becomes incident on the disc surface has deviated from 1°, the interference prevention condition “ΔL>Lc” can be cleared. This means that the present invention is hardly influenced by any tilt of the disc.

Since two-layered disc 100 which satisfies relation (1) is used as next-generation DVD disc 100 according to the present invention, coherence length Lc given by equation (4) can be shorter than optical path difference ΔL given by equation (2). That is, an apparatus which uses disc 100 according to the present invention (e.g., an apparatus shown in FIG. 5 to be described later) is free from the influence of light wave interference between light u₀ reflected by the surface of cover layer 101 and light u₂ reflected by lower recording layer (second recording layer) 112 of disc 100. As a result, focusing servo or the like can be stably executed.

As can be seen from the above description, according to the present invention, since the influence of light wave interference can be avoided, an optical disc apparatus which uses a DVD disc (independently of a one-sided disc/two-sided disc) as a recording medium, and an optical disc apparatus which uses a DVD disc (independently of a one-sided disc/two-sided disc) compatible to high-definition video recording, i.e., a so-called high-definition DVD that will come into the market in the near future can implement accurate recording/reproduction.

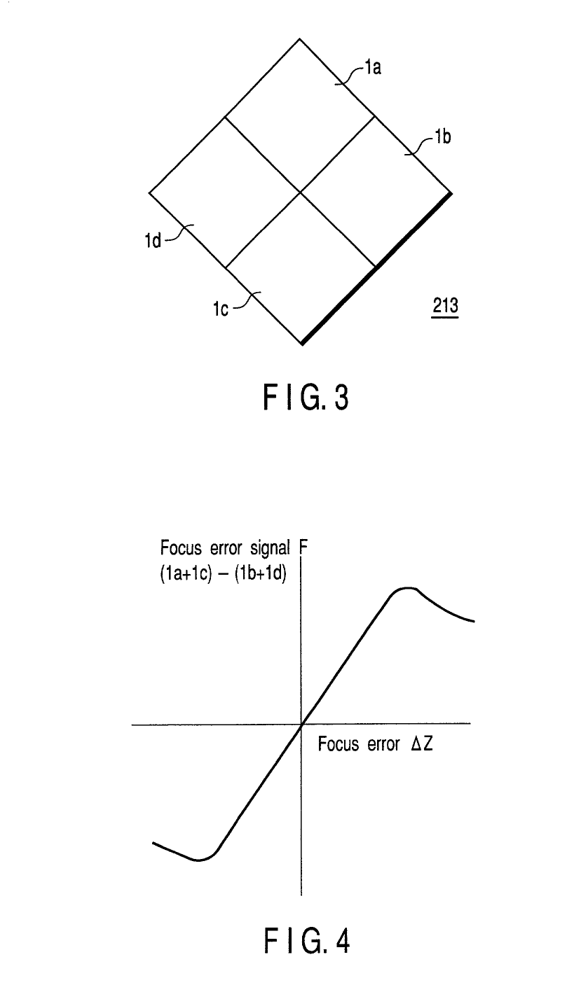

FIG. 3 is a front view of a photosensor which is built in the optical system shown in FIG. 2, and is used to acquire a focus error signal. Photodetector 213 shown in FIG. 2 comprises four-split photodetection elements 1a to 1d, as shown in FIG. 3. Focus error signal F can be obtained by a known astigmatism method using this photodetector 213 as follows. That is, the outputs from those of photodetection elements 1a to 1d that are located on diagonal lines (1a and 1c, and 1b and 1d) are added, the other sum signal [1b+1d] is subtracted from one sum signal [1a+1c], and focus error signal F is obtained from this difference signal [1a+1c]−[1b+1d]).

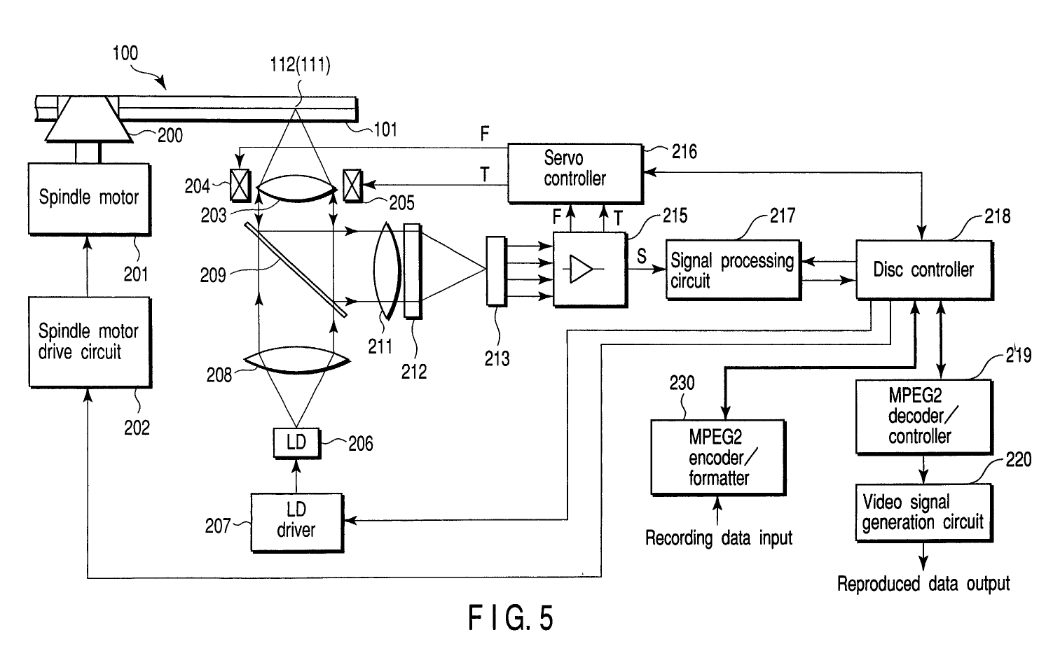

FIG. 4 is a graph for explaining the characteristics of focus error signal F detected by the photosensor shown in FIG. 3. In the example shown in FIG. 4, when the focus point of objective lens 203 is located behind a target position (e.g., an information pit position of lower recording layer 112), a focus error (ΔZ) is generated in the upper right, first quadrant in FIG. 4; when the focus point of objective lens 203 is located in front of the target position, a focus error (−ΔZ) is generated in the lower left, third quadrant in FIG. 4. That is, the polarity (the sign of ΔZ) and amount (the magnitude of ΔZ) change depending on the direction and distance that the focus point of objective lens 203 deviates from the target position. In other words, focus error signal F which linearly changes with respect to focus direction deviation ΔZ of objective lens 203 can be acquired. As a result, accurate focusing control can be made, thus preventing S/N drop of a reproduced signal and an increase in jitter.

When a two-layered disc in which Δh does not satisfy relation (1) (a disc that does not conform to the present invention) is used, coherence length Lc becomes longer than optical path difference ΔL. In this case, only a focus error signal (not shown) that pulsates with respect to focus direction deviation ΔZ of objective lens 203 is acquired, and it becomes difficult to implement stable, accurate focusing servo.

FIG. 5 is a block diagram for explaining an optical disc apparatus (e.g., a next-generation DVD player or recorder) according to an embodiment of the present invention. In the optical disc apparatus shown in FIG. 5, next-generation DVD disc 100 is rotated by spindle motor 201 at a rotational speed of, e.g., 1350 rpm while being chucked on tapered cone 200. Spindle motor 201 is driven by spindle motor drive circuit 202.

A recording/reproduction optical system shown in FIG. 5 has the following arrangement. That is, objective lens 203 is arranged to face the surface of cover layer 101 of next-generation DVD disc 100. This objective lens 203 undergoes movement control in the optical axis direction by focus coil 204 and in the track width direction (disc radial direction) by tracking coil 205. At a position opposing objective lens 203, semiconductor laser diode (to be referred to as laser diode LD hereinafter) 206 is arranged to be movable together with objective lens 203. This laser diode LD 206 is energized by LD driver 207.

A laser beam emitted by laser diode LD 206 is converted into a collimated beam by collimate lens 208, and the collimated beam then enters polarization beam splitter 209. The laser beam emitted by laser diode LD 206 normally has an elliptic far-field pattern. If a circular pattern is required, a beam shaping prism (not shown in FIG. 5) can be inserted after collimate lens 208.

Upon recording or reproduction, the laser beam, which has become incident on cover layer 101 of DVD disc 100 via objective lens 203, is transmitted through upper recording layer (first recording layer) 111, and is focused as a small beam spot on lower recording layer (second recording layer: reflecting layer) 112. Light reflected by lower recording layer 112 passes through objective lens 203 in a direction opposite to incoming light, and is reflected by polarization beam splitter 209. The reflected beam enters photodetector 213 via a detection optical system including focusing lens 211, cylindrical lens 212, and the like.

Photodetector 213 comprises four photodetection elements 1a to 1d arranged on a single plane, as shown in, e.g., FIG. 3. The detection outputs from these four photodetection elements 1a to 1d are input to amplifier array 215, which comprises a plurality of amplifiers, adder/subtractor, and the like, and generates focus error signal F, tracking error signal T, and reproduced signal S. Note that tracking error signal T can be obtained by a known push-pull method. Also, focus error signal F can be obtained by a known astigmatism method. In this astigmatism method, the outputs from those of photodetection elements 1a to 1d in FIG. 3 that are located on diagonal lines (1a and 1c, and 1b and 1d) are added, the other sum signal [1b+1d] is subtracted from one sum signal [1a+1c], and focus error signal F is obtained from this difference signal ([1a+1c]−[1b+1d]).

Focus error signal F and tracking error signal T output from amplifier array 215 are respectively supplied to focus coil 204 and tracking coil 205 via servo controller 216. With these signals, objective lens 203 undergoes movement control in the optical axis direction and track width direction, thus focusing a laser beam on lower recording layer 112 of DVD disc 100 and tracking a beam spot to a target track.

On the other hand, reproduced signal S from amplifier array 215 is input to signal processing circuit 217, and undergoes waveform equalization and binarization processes. Although not shown, in the binarization process, the reproduced signal that has undergone waveform equalization is supplied to a PLL (phase locked loop circuit) and data identification circuit, thus extracting channel clocks as basic clocks upon recording information on DVD disc 100 from the reproduced signal by the PLL. By identifying “0” or “1” of the reproduced signal on the basis of the channel clocks, data identification of information recorded on DVD disc 100 is made, thus obtaining data pulses. That is, the reproduced signal that has undergone waveform equalization is compared with an appropriate threshold value within a predetermined duration (detection window width or window width) with reference to the timings of the leading or trailing edges of the channel clocks, thus achieving data identification. The data pulses detected by signal processing circuit 217 in this way are input to disc controller 218, and undergo format decoding, error correction, and the like. After that, the data pulses are input to MPEG2 decoder/controller 219 as a bitstream of moving picture information.

On DVD disc 100, data obtained by compression-encoding moving picture information according to MPEG2 are recorded as a pit pattern on lower recording layer 112. Hence, MPEG2 decoder/controller 219 decodes (expands) the input bitstream to reproduce original moving picture information. The reproduced moving picture information is input to video signal generation circuit 220, which converts the information into a video signal of a predetermined television format such as NTSC or the like by appending a blanking signal and the like to it. The converted video signal is output as reproduced data, and is displayed on a display (not shown).

The reproduction system has been explained. The recording system will be briefly described below. Recording data obtained by A/D-converting an NTSC video signal or the like is input to MPEG2 encoder/formatter 230. The input recording data is MPEG-encoded (compressed), and is packetized in a predetermined data format to be converted into a predetermined bitstream, which is sent to disc controller 218. The bitstream is then sent to LD driver 207, which converts the bitstream into a recording signal. A recording laser driving waveform corresponding to this recording signal is sent to laser diode LD 206. Information is recorded on a phase-change recording layer of lower recording layer 112 (and/or upper recording layer 111) by a laser beam which is modulated in correspondence with the recording laser driving waveform.

In the above embodiment, the DVD player/recorder has been exemplified as an example of an optical disc. However, the present invention can also be applied to a DVD-ROM, DVD-RAM, DVD-R, DVD-RW, and the like used to record/reproduce programs and/or computer data, and the like.

Note that the present invention is not limited to the aforementioned embodiments, and various modifications may be made without departing from the scope of the invention when it is practiced. The respective embodiments may be combined as needed as long as possible, and combined effects can be obtained in such case.

Furthermore, the embodiments include inventions of various stages, and various inventions can be extracted by appropriately combining a plurality of required constituent elements disclosed in this application. For example, even when some required constituent elements are deleted from all the required constituent elements disclosed in the embodiments, an arrangement from which those required constituent elements are deleted can be extracted as an invention if the effect of the present invention is obtained.

The present invention specifies the thickness of the space layer in terms of optics so as to prevent interference between light directly reflected by the surface of the information medium (next-generation DVD disc or the like), and light which is transmitted through the first recording layer (upper recording layer) and space layer and is reflected by the second recording layer (lower recording layer). For this reason, noise due to interference can be prevented from appearing in a focus signal, and satisfactory focus detection can be achieved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information medium with a multi-layered structure, which has a lower recording layer, an upper recording layer formed on said lower recording layer via a space layer having a first predetermined thickness, and a cover layer which is formed on said upper recording layer and has a second predetermined thickness,
wherein when λ₀ represents a central wavelength of a light beam used to read recorded information from said lower or upper recording layer, Δλ represents a broadening or half-width of the wavelength of the light beam, n₂ represents a refractive index of said space layer, and NA represents a numerical aperture of an objective lens used to focus the light beam on said lower or upper recording layer,
the first predetermined thickness of said space layer is determined by a difference between a length determined by λ₀, Δλ, n₂, and NA, and the second predetermined thickness of said cover layer.

2. A medium according to claim 1, wherein when Δh represents the first predetermined thickness, and h represents the second predetermined thickness, Δh is determined based on:
Δh≧λ₀²/(2·Δλ·[n₂²−NA²]^{1/2})−h

3. A medium according to claim 1, wherein Δh is determined to have a value approximately ⅕ of the value of h as a lower limit value.

4. A medium according to claim 1, wherein when Δh represents the first predetermined thickness, and h represents the second predetermined thickness, Δh is determined to have the value of h as an upper limit value.

5. A medium according to claim 1, wherein when λ₀=400 nm to 405 nm, Δλ=0.1 nm to 1.0 nm, n₂=1.61 to 1.62, NA=0.85±0.01, h=100 μm 1 μm, and Δh represents the first predetermined thickness, Δh is determined to have a value approximately 1/10 of h as a lower limit value.

6. A recording method that uses an information medium with a multi-layered structure which has a lower recording layer, an upper recording layer formed on said lower recording layer via a space layer having a first predetermined thickness, and a cover layer which is formed on said upper recording layer and has a second predetermined thickness, and in which when λ₀ represents a central wavelength of a light beam used to read recorded information from said lower or upper recording layer, Δλ represents a broadening or half-width of the wavelength of the light beam, n₂ represents a refractive index of said space layer, and NA represents a numerical aperture of an objective lens used to focus the light beam on said lower or upper recording layer, the first predetermined thickness of said space layer is determined by a difference between a length determined by λ₀, Δλ, n₂, and NA, and the second predetermined thickness of said cover layer,
wherein information is recorded on said upper or lower recording layer using a laser beam having central wavelength λ₀.

7. An optical disc which has an optical disc structure using a substrate having thickness H, and in which a first recording layer formed with signal pits is arranged on a portion having distance h from the surface, a second recording layer formed with signal pits is also arranged on a portion having distance h+Δh from the surface, a space layer having thickness Δh is arranged between said first and second recording layers, and a cover layer having thickness h is arranged between said first recording layer and the disc surface,
wherein the thickness of said space layer is specified so that a coherence length determined by a central wavelength and its half-width of an exit light power spectrum of a light source of a laser beam with which said first or second recording layer is irradiated is smaller than an optical path difference between light directly reflected by a surface of said cover layer, and light which is transmitted through said cover layer and said space layer, is reflected by said second recording layer, and leaves said cover layer.

8. A disc according to claim 7, wherein when λ₀ represents a central wavelength of the laser beam, Δλ represents a half-width of the wavelength of the laser beam, n₂ represents a refractive index of said space layer, NA represents a numerical aperture of an objective lens used to focus the light beam on said first or second recording layer, Δh represents the thickness of said space layer, and h represents the thickness of said cover layer, Δh is determined based on:
Δh≧λ₀²/(2·Δλ·[n₂²−NA²]^{1/2})−h

9. An optical disc apparatus which irradiates an optical disc of claim 7 with a laser beam which is emitted by the light source via an objective lens, and records or reproduces information on or from said first or second recording layer by the irradiated laser beam, wherein a focus error of the objective lens is detected on the basis of a signal obtained by detecting some light components of the laser beam reflected by said first or second recording layer.

10. An information recording apparatus that uses an information medium with a multi-layered structure which has a lower recording layer, an upper recording layer formed on said lower recording layer via a space layer having a first predetermined thickness, and a cover layer which is formed on said upper recording layer and has a second predetermined thickness, and in which when λ₀ represents a central wavelength of a light beam used to read recorded information from said lower or upper recording layer, Δλ represents a broadening or half-width of the wavelength of the light beam, n₂ represents a refractive index of said space layer, and NA represents a numerical aperture of an objective lens used to focus the light beam on said lower or upper recording layer, the first predetermined thickness of said space layer is determined by a difference between a length determined by λ₀, Δλ, n₂, and NA, and the second predetermined thickness of said cover layer,
wherein information is recorded on at least one of said upper and lower recording layers.

11. An information recording method that uses an information medium with a multi-layered structure which has a lower recording layer, an upper recording layer formed on said lower recording layer via a space layer having a first predetermined thickness, and a cover layer which is formed on said upper recording layer and has a second predetermined thickness, and
in which when λ₀ represents a central wavelength of a light beam used to read recorded information from said lower or upper recording layer, Δλ represents a broadening or half-width of the wavelength of the light beam, n₂ represents a refractive index of said space layer, and NA represents a numerical aperture of an objective lens used to focus the light beam on said lower or upper recording layer,
the first predetermined thickness of said space layer is determined by a difference between a length determined by λ₀, Δλ, n₂, and NA, and the second predetermined thickness of said cover layer,
wherein information is recorded on at least one of said upper and lower recording layers.
